(19) United States
(12) Patent Application Publication
(10) Pub. No.: US 2011/0145658 A1
(43) Pub. Date: Jun. 16, 2011

(54) ELECTRONIC APPARATUS AND METHOD OF CONTROLLING ELECTRONIC APPARATUS

(75) Inventors: Tsuyoshi Wasamoto, Matsumoto-shi (JP); Toshiaki Watanabe, Shiojiri-shi (JP)

(73) Assignee: Seiko Epson Corporation, Tokyo (JP)

(21) Appl. No.: 12/967,825

(22) Filed: Dec. 14, 2010

(30) Foreign Application Priority Data
Dec. 14, 2009 (JP) 2009-282405

(51) Int. Cl. G06F 11/25; G06F 12/00

(52) U.S. Cl. 714/47.1; 711/154; 711/E12.001; 714/E11.024

(57) ABSTRACT

An electronic apparatus is provided. A main control section outputs data including fiscal information input from an interface. A recording control section is connected to the main control section. The recording control section controls a recording section on the basis of the data output from the main control section to issue a receipt. A memory control section is connected to the main control section and a memory. The memory control section reads and writes the fiscal information from and to the memory under the control of the main control section. When the data is input to the main control section from the interface, the main control section controls the memory control section to write the fiscal data to the memory. A log creation section creates a log that the main control section controls the memory control section to read the fiscal information from the memory.

The disclosure of Japanese Patent Application No. 2009-282405 filed on Dec. 14, 2009, including specification, drawings and claims are incorporated herein by reference in its entirety.

### BACKGROUND

The present invention relates to an electronic apparatus which stores fiscal information, and a method of controlling an electronic apparatus.

In the related art, an electronic apparatus (an electronic cash register or a receipt printer) is provided in a shop or the like which sells articles and provides services. The electronic apparatus includes a writable nonvolatile memory (fiscal ROM) which stores fiscal information including information regarding sales transactions of articles or the like (information regarding sales or information regarding the tax amount or the like) (for example, see Patent Document 1). The fiscal information stored in the memory is used as information for ascertaining the actual status of transactions of the shop when a state institution, such as the government, collects tax from the shop.
Patent Document 1: JP-A-05-120567

As described above, the fiscal information stored in the memory is used as information for ascertaining the actual status of transactions of the shop. Thus, it is necessary to prevent the fiscal information stored in the memory from being falsified. In particular, in some countries, the law may require that the electronic apparatus is configured to prevent the fiscal information stored in the memory from being falsified.

### SUMMARY

It is therefore an object of at least one embodiment of the present invention to provide an electronic apparatus which can detect reading of data from a memory through unauthorized access as a first step towards falsification of the fiscal information, and a method of controlling an electronic apparatus.

In order to achieve at least one of the above-described objects, according to an aspect of the embodiments of the present invention, there is provided an electronic apparatus, comprising: a main control section that outputs data including fiscal information input from an interface; a recording control section connected to the main control section, the recording control section that controls a recording section on the basis of the data output from the main control section to issue a receipt; and a memory control section connected to the main control section and a memory, the memory control section that reads and writes the fiscal information from and to the memory under the control of the main control section, wherein when the data is input to the main control section from the interface, the main control section controls the memory control section to write the fiscal data to the memory, and wherein the electronic apparatus further comprises a log creation section that creates a log that the main control section controls the memory control section to read the fiscal information from the memory.

With this configuration, in a situation where the fiscal information has been read in the past, on the basis of the log created by the log creation section, whether the reading of data including the fiscal information is performed in a form such that unauthorized access is likely to have been performed in the past can be detected. If data including the fiscal information is generated in a unique format and then stored in the memory through the function of the memory control section, when a person who does not know which format is used for generating the stored data attempts to unauthorizedly access the memory and read data, it is determined that data is read in a form different from the normal form of reading data, such as frequently reading data from the memory for a short time. Thus, it is possible to more appropriately detect reading of data through unauthorized access on the basis of the log created by the log creation section. Data may be stored after being encrypted, for example, after being compressed according to a specific standard.

In the electronic apparatus according to the aspect of the embodiments of the present invention, when the main control section controls the memory control section to read the fiscal information from the memory on the basis of a read command input from the interface, the main control section may output a read request to the memory control section, and the memory control section may access the memory, read the fiscal information from the memory and output the fiscal information to the interface on the basis of the read request input from the main control section, and the log creation section may create a read request log which is a log that the read command is input from the interface or a log that the main control section outputs the read request to the memory control section, and a read performance log which is a log that the memory control section accesses the memory and read the fiscal information from the memory.

With the above-described configuration, in reading the fiscal information from the memory, the read command is input from the interface, the main control section outputs the read request to the memory control section, and the memory control section accesses the memory and reads the fiscal information from the memory on the basis of the read request input from the main control section. Thus, the read command input from the interface or the read request output from the main control section to the memory control section should correspond to processing in which the memory control section reads data from the memory. When the read command or the read request does not correspond to the processing for reading data from the memory, there is a possibility that unauthorized access to the memory has been performed.

As a result, with this configuration, the reading of the fiscal information through unauthorized access can be appropriately detected on the basis of the read request log and the read performance log.

In the electronic apparatus according to the aspect of the embodiments of the present invention, the electronic apparatus may further comprise an unauthorized access detection section that detects the number of times in which the read command is input from the interface or the number of times in which the main control section outputs the read request to the memory control section on the basis of the read request log created by the log creation section, detect the number of the times in which the memory control section accesses the memory and reads the fiscal information from the memory on the basis of the read performance log, and then detect unauthorized access to the memory on the basis of detection results.

With the above-described configuration, in reading the fiscal information from the memory, the read command is input from the interface, the main control section outputs the read request to the memory control section, and the memory control section accesses the memory and reads the fiscal information from the memory on the basis of the read request input from the main control section. Thus, the number of times in which the read command is input from the interface or the number of times in which the main control section has output the read request to the memory control section should coincide with the number of times of processing in which the memory control section reads the fiscal information from the memory. When not coincide with each other, there is a possibility that the fiscal information has been read from the memory through unauthorized access.

As a result, with the above-described configuration, the reading of the fiscal information through unauthorized access can be appropriately detected on the basis of the number of times, in which the main control section has output the read request to the memory control section, detected on the basis of the read request log and the number of times, in which the memory control section has accessed the memory and read the fiscal information from the memory, detected on the basis of the read performance log.

The electronic apparatus according to the aspect of the embodiments of the present invention, the electronic apparatus may further comprising a timer section that measures date and time, the log creation section may create the log in association with date and time at which the main control section controls the memory control section to read the fiscal information from the memory, on the basis of the date and time measured by the timer section.

With this configuration, it becomes possible to detect the history of the date and time at which the main control section has controlled the memory control section to read the fiscal information from the memory, making it possible to detect unauthorized access to the memory which is performed in a form different from normal access.

In the electronic apparatus according to the aspect of the embodiments of the present invention, the electronic apparatus may further comprise an unauthorized access detection section that detects a history of the date and time at which the main control section controls the memory control section to read the fiscal information from the memory on the basis of the log created by the log creation section, and then detects unauthorized access to the memory on the basis of the detected history.

With this configuration, it becomes possible to detect the difference between the history when normal access has been performed and the history when unauthorized access has been performed, making it possible to detect unauthorized access on the basis of the detected difference.

In the electronic apparatus according to the aspect of the embodiments of the present invention, the electronic apparatus may be connectable to an external device which is authorized to read the fiscal information from the memory, and the log creation section may create a log regarding a connection status of the external device.

With this configuration, it becomes possible to detect the status of access to the memory by the external device on the basis of the log regarding the connection status of the external device and the log that the main control section has controlled the memory control section to read the fiscal information from the memory, making it possible to detect unauthorized access on the basis of the detection result.

In the electronic apparatus according to the aspect of the embodiments of the present invention, the electronic apparatus may further comprise an unauthorized access detection section that detects unauthorized access to the memory on the basis of the log that the main control section controls the memory control section to read the fiscal information from the memory and the log regarding the connection status of the external device, which are created by the log creation section.

With this configuration, it becomes possible to detect the status of access to the memory by the external device on the basis of the log regarding the connection status of the external device and the log that the main control section has controlled the memory control section to read the fiscal information from the memory, making it possible to detect unauthorized access on the basis of the detection result.

According to another aspect of the embodiments of the present invention, there is also provided a method of controlling an electronic apparatus including: a main control section that outputs data including fiscal information input from an interface; a recording control section connected to the main control section, the recording control section that controls a recording section on the basis of the data output from the main control section to issue a receipt; and a memory control section connected to the main control section and a memory, the memory control section that reads and writes the fiscal information from and to the memory under the control of the main control section, the method comprising: controlling the memory control section to write the fiscal data to the memory when the data is input to the main control section from the interface; detecting that the main control section controls the memory control section to read the fiscal information from the memory; and creating a log on the basis of a result of the detecting.

With this control method, in a situation where the fiscal information has been read in the past, on the basis of the log created by a log creation section, whether the reading of data including the fiscal information in a form such that unauthorized access is likely to be performed in the past can be detected. In particular, data including the fiscal information is stored in the memory in a unique format through the function of the memory control section. For this reason, in reading the stored data through unauthorized access, it is determined that data is read in a form different from the normal form of reading data, such as frequently reading data from the memory for a short time. Thus, the reading of data through unauthorized access can be more appropriately detected on the basis of the log created by the log creation section.

According to the aspects of the invention, it is possible to detect reading of data from the memory through unauthorized access as a first step towards falsification of the fiscal information.

### BRIEF DESCRIPTION OF THE DRAWINGS

In the accompanying drawings:

FIG. 1 is an exterior perspective view of a fiscal printer according to an embodiment of the invention.

FIG. 2 is an exterior perspective view of the fiscal printer.

FIG. 3 is a circuit configuration diagram of the fiscal printer.

FIG. 4 is a diagram showing an example of information recorded on a receipt.

FIG. 5 is a flowchart showing the operation of the fiscal printer.

FIG. 6 is a flowchart showing the operation of the fiscal printer.

FIG. 7 is a flowchart showing the operation of the fiscal printer.

FIG. 8 is a flowchart showing the operation of the fiscal printer.

FIG. 9 is a diagram schematically showing the configuration of a command output log.

FIGS. 10A and 10B are diagrams showing a first read/write performance log and a second read/write performance log.

FIG. 11 is a diagram schematically showing the configuration of a connection status log.

FIG. 12 is a flowchart showing the operation of the fiscal printer.

FIG. 13 is a flowchart showing the operation of the fiscal printer.

FIG. 14 is a flowchart showing the operation of the fiscal printer.

### DETAILED DESCRIPTION OF THE EMBODIMENTS

Hereinafter, an embodiment of the invention will be described with reference to the drawings.

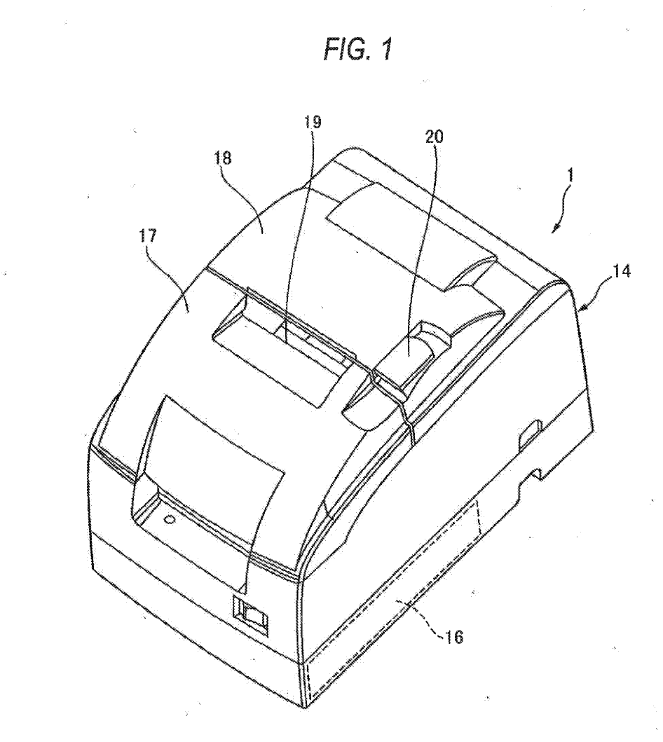

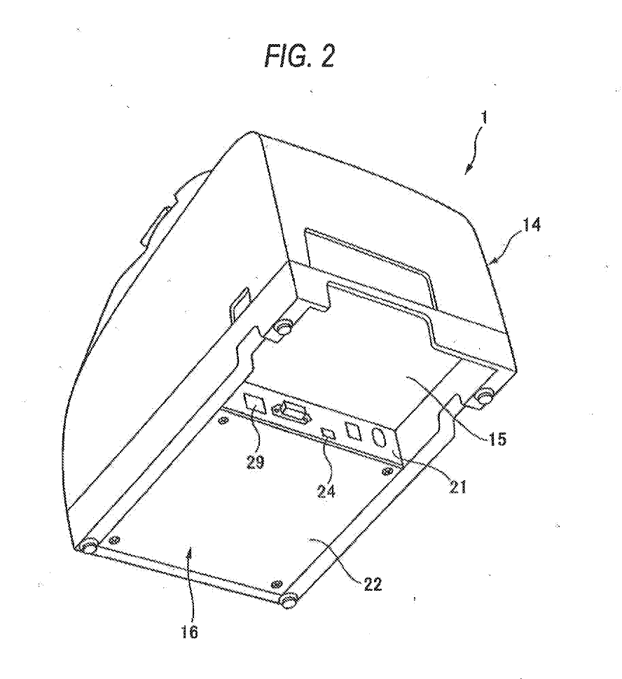

FIG. 1 is an exterior perspective view of a fiscal printer 1 (electronic apparatus) according to this embodiment when viewed from above. FIG. 2 is an exterior perspective view of the fiscal printer 1 when viewed from below.

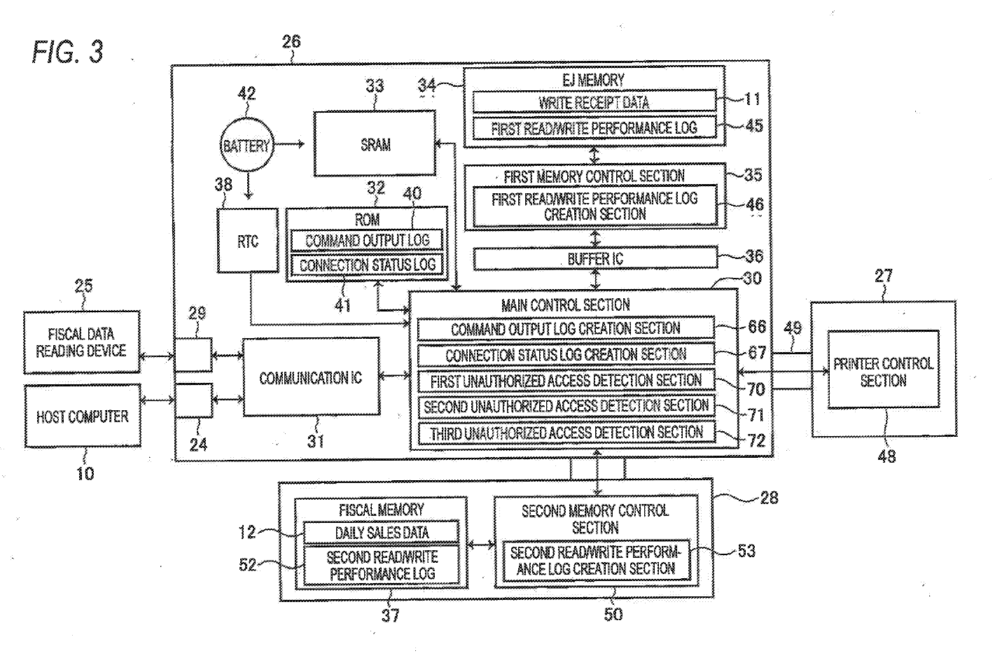

The fiscal printer 1 of this embodiment is connected to a host computer 10 (FIG. 3), such as a POS terminal, and issues a receipt and stores data including fiscal information input from the host computer 10 under the control of the host computer 10. It is assumed that the fiscal information references information regarding sales transactions of articles or the like (information regarding sales or information regarding the tax amount or the like), and information which is predefined as information to be stored. The fiscal information is used as information which is referenced, for example, when a state institution, such as the government, ascertains the actual status of transactions of the shop so as to collect tax from a shop. In this embodiment, write receipt data 11 (FIG. 3) and daily sales data 12 (FIG. 3) described below are stored in the fiscal printer 1 as data including fiscal information.

As shown in FIGS. 1 and 2, the fiscal printer 1 includes a printer main body 14 and a fiscal unit 16 which is fastened to a bottom portion 15 of the printer main body 14.

Inside the printer main body 14 are housed a transport mechanism for transporting a roll sheet, a mechanism or device (recording section) for issuing a receipt, such as a recording mechanism for recording an image on a roll sheet, a roll sheet accommodating section for accommodating a roll sheet, and the like.

As shown in FIG. 1, the printer main body 14 includes a front opening/closing cover 17 which covers the front portion of the top surface of the printer main body 14, and a rear opening/closing cover 18 which covers the rear portion of the top surface of the printer main body 14. A recording sheet discharge port 19 is formed between the front opening/closing cover 17 and the rear opening/closing cover 18 so as to extend in the width direction. If a slide button 20 is manipulated which is arranged lateral to the recording sheet discharge port 19, a lock mechanism (not shown) is unlocked, such that the rear opening/closing cover 18 can be opened. If the rear opening/closing cover 18 is opened, the roll sheet accommodating section is exposed, such that the roll sheet can be replaced. If the front opening/closing cover 17 is opened, replacement of an ink ribbon or the like can be performed.

The fiscal unit 16 includes a boxlike case 21 which has an opening at the bottom, and a bottom plate 22 which covers the opening of the case 21. At the rearward lateral surface of the case 21 are provided a PC connector 24 to which the host computer 10 is connected, and a fiscal connector 29 to which a fiscal data reading device 25 described below (external device) is connected, in addition to a power supply adaptor, a network cable, and a connector to which a cable connected to a board inside the printer main body 14 is connected.

Inside the fiscal unit 16 are provided a management board 26, a printer board 27, and a sub board 28 (all are shown in FIG. 3).

FIG. 3 is a circuit configuration diagram of the fiscal printer 1. In particular, FIG. 3 schematically shows the circuit configuration of the management board 26, the printer board 27, and the sub board 28 provided in the fiscal unit 16.

As shown in FIG. 3, on the management board 26 are mounted a main control section 30, the PC connector 24, the fiscal connector 29, a communication IC 31 (interface), a ROM 32, an SRAM 33, an RTC 38 (timer section), an EJ memory 34, a first memory control section 35 (memory control section), and a buffer IC 36.

The main control section 30 centrally controls the respective sections of the fiscal printer 1, and includes a CPU and other peripheral circuits. The main control section 30 includes a command output log creation section 66, a connection status log creation section 67, a first unauthorized access detection section 70, a second unauthorized access detection section 71, and a third unauthorized access detection section 72. These sections will be described below.

The PC connector 24 is a connector which is connected to the host computer 10 at the time of normal use of the fiscal printer 1. The host computer 10 outputs a printing command related to issuance of a receipt to the fiscal printer 1 through the PC connector 24 and also outputs daily sales data 12 which is data including fiscal information.

The fiscal connector 29 is a connector to which the fiscal data reading device 25 (external device) is connected. The fiscal data reading device 25 is a device for reading data stored in the EJ memory 34 or a fiscal memory 37 described below, and only an authorized person, such as a person who belongs to a state institution (the government or the like), can possess the fiscal data reading device 25. Although the above-described host computer 10 is maintained in a state of being connected to the PC connector 24, unlike the host computer 10, the fiscal data reading device 25 is appropriately connected to the fiscal connector 29 in reading data.

The communication IC 31 is connected to the PC connector 24 and the fiscal connector 29, and performs transmission/reception of data between host computer 10 and the fiscal data reading device 25 under the control of the main control section 30. In particular, the communication IC 31 can detect whether the fiscal data reading device 25 is communicably connected to the fiscal connector 29 or not on the basis of an output value from the fiscal connector 29. The main control section 30 can detect the time period (connection start time and disconnection time), in which the fiscal data reading device 25 has been connected to the fiscal connector 29, on the basis of the detection value of the communication IC 31.

The ROM 32 stores a control program (firmware) or control data which is used when the main control section 30 performs various types of control. In this embodiment, as the ROM 32, a nonvolatile memory, such as an EEPROM or a flash ROM, is used in which data is rewritable. The ROM 32 stores a command output log 40 (read request log) and a connection status log 41, which will be described below.

The SRAM 33 is a memory which functions as the work area of the CPU of the main control section 30, and temporarily stores various kinds of data. While power is supplied from the commercial power source to the fiscal printer 1, power is also supplied from the commercial power source to the SRAM 33. Meanwhile, when power from the commercial power source is shut off, power is supplied from a battery 42 to the SRAM 33.

The RTC 38 (Real-time clock) outputs data representing the current date and time (year, month, day, and time) and the current day of the week to the main control section 30. Similarly to the SRAM 33, while power is supplied from the commercial power source to the fiscal printer 1, power is supplied from the commercial power source to the RTC 38. Meanwhile, when power from the commercial power source is shut off, power is supplied from the battery 42 to the RTC 38.

The EJ (Electric Journal) memory 34 is a NAND-type flash memory which can store a large quantity of data. As shown in FIG. 3, the EJ memory 34 stores write receipt data 11 and a first read/write performance log 45 (read performance log), which will be described below. The EJ memory 34 functions as a memory in which data can be written into one address once only under the control of the first memory control section 35. Thus, data written into the EJ memory 34 is prevented from being edited later, preventing data stored in the EJ memory 34 from being falsified. The EJ memory 34 is configured such that a dedicated storage area is allocated as the area where the first read/write performance log 45 is stored, and the first read/write performance log 45 which is stored in the relevant storage area can be appropriately updated.

The first memory control section 35 includes a CPU, and reads/writes data with respect to the EJ memory 34 under the control of the main control section 30. The first memory control section 35 includes a first read/write performance log creation section 46, which will be described below.

The buffer IC 36 controls a buffer which is provided to improve efficiency of reading and writing of data with respect to the EJ memory 34.

The EJ memory 34, the first memory control section 35, and the buffer IC 36 are sealed to the management board 26 with epoxy resin and, after the EJ memory 34 is physically detached from the management board 26, data stored in the EJ memory 34 is prevented from being falsified. Both the EJ memory 34 and the fiscal memory 37 may be called a fiscal memory. The information stored in the EJ memory 34 and the fiscal memory 37 may be stored in a single memory.

The operation when the first memory control section 35 reads/writes write receipt data 11 with respect to the EJ memory 34 under the control of the main control section 30 will be described below in detail.

On the printer board 27 is mounted a printer control section 48 (recording control section). The printer control section 48 includes a CPU and various peripheral circuits, and controls the above-described transport mechanism for transporting the roll sheet and the mechanism or device (recording section) for issuing a receipt, such as an image recording mechanism for recording an image on the roll sheet, to issue a receipt on the basis of the printing command. The printer board 27 is communicably connected to the main control section 30 through a dedicated connector 49.

In this embodiment, in issuing a receipt, first, the host computer 10 connected to the fiscal printer 1 generates a printing command and outputs the generated printing command to the main control section 30 through the PC connector 24. The main control section 30 to which the printing command is input outputs the input printing command to the printer control section 48 through the dedicated connector 49.

On the sub board 28 are mounted the fiscal memory 37 and a second memory control section 50 (memory control section).

The fiscal memory 37 is a memory which includes an EPROM. The fiscal memory 37 stores daily sales data 12 and a second read/write performance log 52 (read performance log), which will be described below. The fiscal memory 37 functions as a memory in which data can be written into one address once only under the control of the second memory control section 50. Thus, data written into the fiscal memory 37 is prevented from being edited later, preventing data stored in the fiscal memory 37 from being falsified. The fiscal memory 37 is configured such that a dedicated storage area is allocated as the area where the second read/write performance log 52 is stored, and the second read/write performance log 52 which is stored in the relevant storage area can be appropriately updated.

The second memory control section 50 includes a CPLD (Complex programmable logic device) serving as a device in which a programmable logic circuit is written, and reads/writes data with respect to the fiscal memory 37 under the control of the main control section 30. The second memory control section 50 includes a second read/write performance log creation section 53, which will be described below.

The fiscal memory 37 and the second memory control section 50 are sealed to the sub board 28 with epoxy resin and, for example, after the fiscal memory 37 is physically detached from the sub board 28, data stored in the fiscal memory 37 is prevented from being falsified.

The operation when the second memory control section 50 reads/writes data with respect to the fiscal memory 37 under the control of the main control section 30 will be described below in detail.

Next, description will be provided for the operation when the first memory control section 35 reads/writes write receipt data 11 with respect to the EJ memory 34 under the control of the main control section 30.

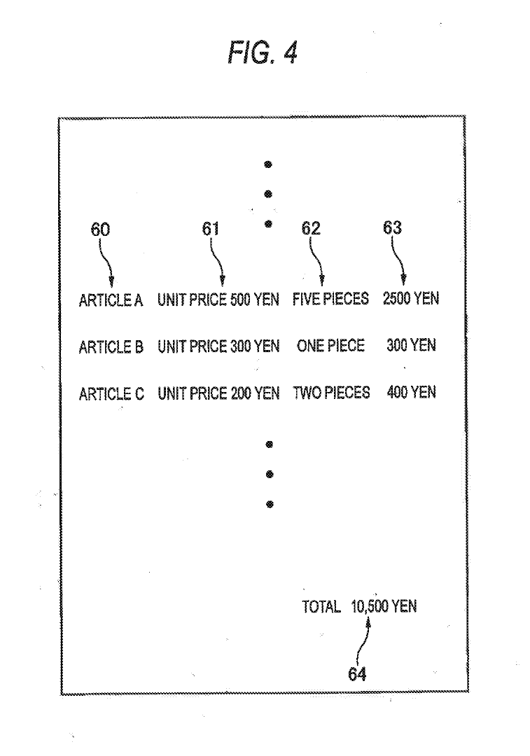

FIG. 4 is a diagram showing an example of a receipt which is issued by the fiscal printer 1.

In the following description, it is assumed that the fiscal printer 1 is installed in a shop which sells articles, and a receipt is issued in accordance with payment when a customer purchases one or multiple articles in the shop. As shown in FIG. 4, it is assumed that, for each purchased article of the customer, on the receipt are recorded article information 60 representing the article, unit price information 61 representing the unit price of each article, number-of-purchased-articles information 62 representing the number of purchased articles, and article purchase price information 63 representing the purchase price of the articles (the unit price of each article×the number of purchased articles) in association with each other. It is also assumed that total purchase price information 64 representing the total purchase price of all articles (the sum of money related to the purchase of each article) is recorded on the receipt.

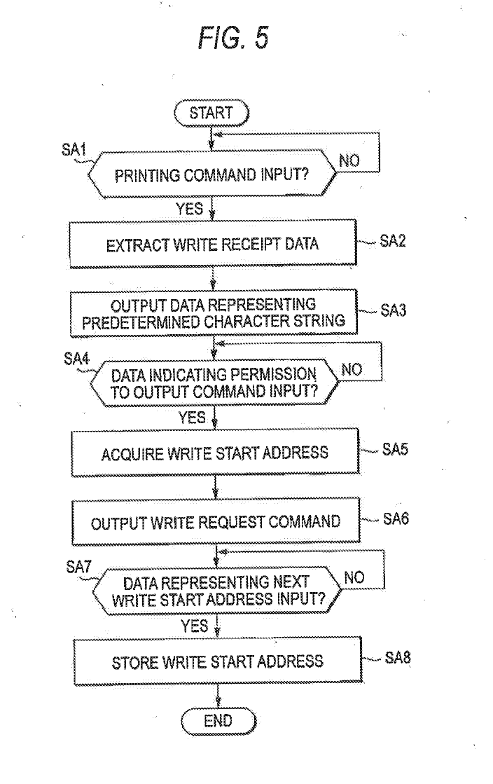

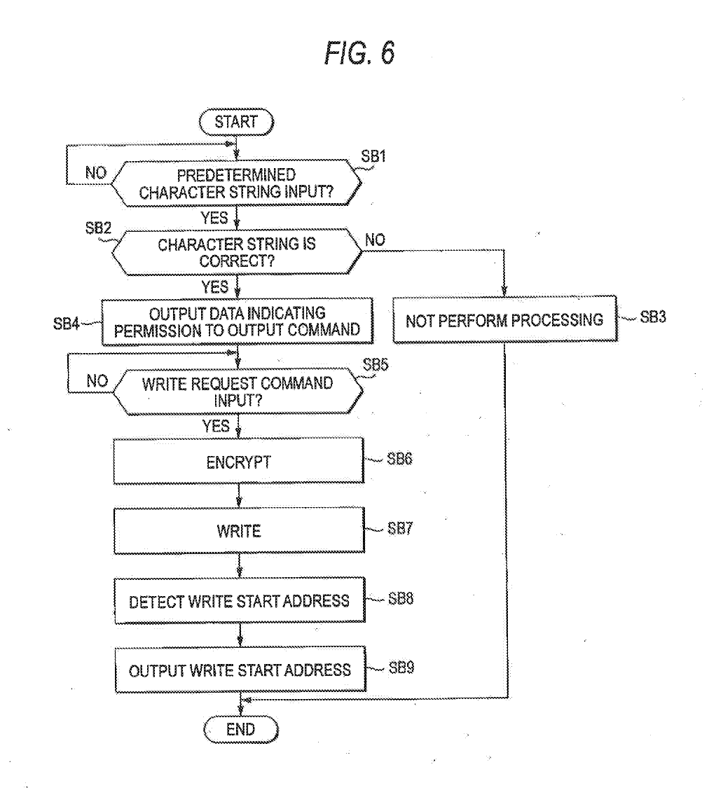

First, description will be provided for the operation when the main control section 30 controls the first memory control section 35 to write write receipt data 11 into the EJ memory 34 with reference to FIGS. 5 and 6.

FIG. 5 is a flowchart showing the operation of the main control section 30 when the main control section 30 controls the first memory control section 35 to write write receipt data 11 into the EJ memory 34. FIG. 6 is a flowchart showing the operation of the first memory control section 35 during the relevant operation.

As the prerequisite for the operation, it is assumed that the host computer 10 generates a printing command for issuing a receipt and outputs the printing command to the main control section 30. The printing command includes data representing the above-described article information 60, unit price information 61, number-of-purchased-articles information 62, article purchase price information 63, and total purchase price information 64, which are recorded on the receipt, as text data.

Referring to FIG. 5, the main control section 30 monitors whether or not a printing command is input (Step SA1). When the printing command is input (Step SA1: YES), the main control section 30 outputs the input printing command to the printer control section 48, and extracts text data representing various kinds of information (article information 60, unit price information 61, number-of-purchased-articles information 62, article purchase price information 63, and total purchase price information 64) from the input printing command. Extracted data is write receipt data 11 (Step SA2).

Next, the main control section 30 outputs data representing a predefined character string to the first memory control section 35 (Step SA3). As described above, in this embodiment, the main control section 30 outputs data representing a predefined character string to the first memory control section 35 before a write request command which is a command to request writing of data with respect to the EJ memory 34 is output to the first memory control section 35. The predefined character string is uniquely defined for every combination of the single main control section 30 and the first memory control section 35 connected to the single main control section 30 in the manufacturing step of the fiscal printer 1. The first memory control section 35 is configured to receive a command, such as a write request command, only when data representing a predefined character string is input. With this configuration, when the first memory control section 35 is connected to a control section which is a control section (CPU) other than the corresponding main control section 30 and executes a program which is not programmed so as to output data representing a predefined character string in outputting a write request command, access to the EJ memory 34 cannot be performed by the relevant control section, preventing unauthorized access to data stored in the EJ memory 34 by such means.

Referring to FIG. 6, the first memory control section 35 monitors whether or not data representing a predefined character string is input (Step SB1). When data representing a predefined character string is input (Step SB1: YES), the first memory control section 35 determines whether or not the character string represented by input data is a predefined character string (Step SB2). When the character string represented by input data is not a predefined character string (Step SB2: NO), the first memory control section 35 does not perform writing of data from the main control section 30 (Step SB3), preventing access to the EJ memory 34 by a control section other than the corresponding main control section 30.

When the character string represented by input data is a predefined character string (Step SB2: YES), the first memory control section 35 outputs data indicating permission to output a command to the main control section 30 (Step SB4).

Referring to FIG. 5, after Step SA3, the main control section 30 determines whether or not “data indicating permission to output a command” is input from the first memory control section 35 (Step SA4). When relevant data is input (Step SA4: YES), the main control section 30 acquires a write start address of data in the EJ memory 34 from the SRAM 33 (Step SA5). The write start address references the address into which writing starts in the memory area of the EJ memory 34 in writing data into the EJ memory 34. In this embodiment, each time data is written into the EJ memory 34, the first memory control section 35 acquires the write start address in writing data into the EJ memory 34 next time, and outputs data representing the acquired write start address to the main control section 30. The main control section 30 stores data representing the write start address in the SRAM 33, when write receipt data 11 is written into the EJ memory 34 next time, acquires the write start address from the SRAM 33, and outputs a write request command for writing data into the storage area represented by the acquired write start address. For this reason, when a write request command is output by any unauthorized means without acquiring the write start address from the SRAM 33, the write start address designated in the write request command is different from the address into which writing can actually start in the EJ memory 34. In this embodiment, when this situation occurs, it is determined that a writing error occurs, preventing data from being written into the EJ memory 34 by unauthorized means.

After the write start address is acquired from the SRAM 33 (Step SA5), the main control section 30 outputs a write request command for writing write receipt data 11 extracted in Step SA2 into the write start address acquired from the SRAM 33 to first memory control section 35 (Step SA6).

Referring to FIG. 6, in Step SB5, the first memory control section 35 determines whether or not the write request command is input from the main control section 30.

When the write request command is input (Step SB5: YES), the first memory control section 35 extracts write receipt data 11 included in the write request command and encrypts write receipt data 11 (Step SB6). A function for decoding encrypted data is provided only in a device, such as the above-described fiscal data reading device 25, in which data including fiscal information is allowed to be regularly read.

Next, the first memory control section 35 writes encrypted write receipt data 11 into the EJ memory 34 (Step SB7), and detects the write start address in writing write receipt data 11 next time (Step SB8). Next, the first memory control section 35 outputs data representing the write start address to the main control section 30 (Step SB9). Encryption may be implemented by data compression. In this case, run-length coding, Huffman coding, or the like may be used. A flash memory or the like is configured such that sectoralization is made and data is generated in a unique format, arranged, and stored. Such a unique format may be used as a kind of encryption.

Referring to FIG. 5, in Step SA7, the main control section 30 monitors whether or not data representing a write start address is input. When data representing a write start address is input (Step SA7: YES), the main control section 30 stores data representing a write start address in the SRAM 33 (Step SA8).

As described above, write receipt data 11 is written into the EJ memory 34 by the first memory control section 35 which is controlled by the main control section 30 and, through the same procedure, daily sales data 12 is written in the fiscal memory 37 by the second memory control section 50 which is controlled by the main control section 30. Daily sales data 12 references data which represents the total sales every day. After the shop is closed, the host computer 10 calculates the total sales on that day, generates daily sales data 12 on the basis of the calculated total sales, and outputs generated daily sales data 12 to the main control section 30. If daily sales data 12 is input, the main control section 30 controls the second memory control section 50 to write daily sales data 12 into the fiscal memory 37 under the same control as the control for the first memory control section 35.

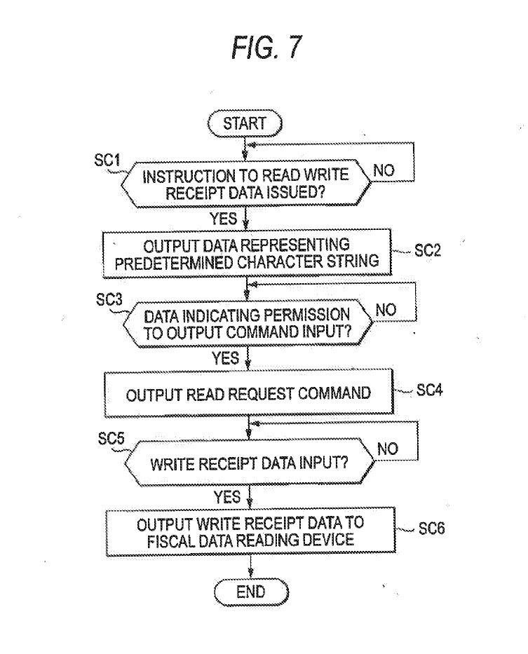

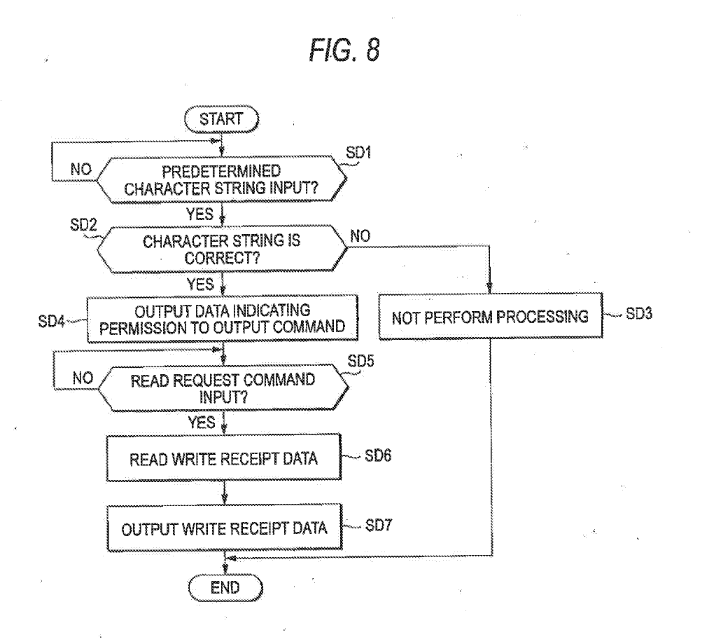

Next, description will be provided for the operation when the main control section 30 controls the first memory control section 35 to read write receipt data 11 from the EJ memory 34 with reference to FIGS. 7 and 8.

FIG. 7 is a flowchart showing the operation of the main control section 30 when the main control section 30 controls the first memory control section 35 to read write receipt data 11 from the EJ memory 34. FIG. 8 is a flowchart showing the operation of the first memory control section 35 during the relevant operation.

In the following operation, it is assumed that the fiscal data reading device 25 is connected to the fiscal printer 1, and the main control section 30 reads write receipt data 11 from the EJ memory 34 on the basis of an instruction (read command) to read data by the fiscal data reading device 25 and outputs read write receipt data 11 to the fiscal data reading device 25.

Referring to FIG. 7, the main control section 30 monitors whether or not a command (read command) which instructs to read write receipt data 11 is input from the fiscal data reading device 25 (Step SC1). When the command is input (Step SC1: YES), the main control section 30 outputs data representing a predefined character string described above to the first memory control section 35 (Step SC2).

Referring to FIG. 8, the first memory control section 35 monitors whether or not data representing a predefined character string is input (Step SD1). When data representing a predefined character string is input (Step SD1: YES), the first memory control section 35 determines whether or not the character string represented by input data is a predefined character string (Step SD2). When the character string represented by input data is not a predefined character string (Step SD2: NO), the first memory control section 35 does not output a data read request from the main control section 30 (Step SD3), preventing access to the EJ memory 34 by a control section other than the main control section 30.

When the character string represented by input data is a predefined character string (Step SD2: YES), the first memory control section 35 outputs data indicating permission to output a command to the main control section 30 (Step SD4).

Referring to FIG. 7, the main control section 30 monitors whether or not “data indicating permission to output a command” is input (Step SC3). When data is input (Step SC3: YES), the main control section 30 outputs a read request command for reading write receipt data 11 to the first memory control section 35 (Step SC4).

Referring to FIG. 8, in Step SD5, the first memory control section 35 determines whether or not a read request command is input from the main control section 30.

When a read request command is input (Step SD5: YES), the first memory control section 35 accesses the EJ memory 34, reads write receipt data 11 from the EJ memory 34 (Step SD6), and outputs read write receipt data 11 to the main control section 30 (Step SD7). Write receipt data 11 output to the main control section 30 is encrypted data or data in a unique format.

Referring to FIG. 7, in Step SC5, the main control section 30 monitors whether or not write receipt data 11 is input from the first memory control section 35 (Step SC5).

When write receipt data 11 is input (Step SC5: YES), the main control section 30 outputs input write receipt data 11 to the fiscal data reading device 25 through the communication IC 31 and the fiscal connector 29 (Step SC6).

As described above, write receipt data 11 is encrypted or put into a unique format, and can be decoded only by the regular fiscal data reading device 25 or the like which has a decoding function.

Through the same procedure, daily sales data 12 is read from the fiscal memory 37 by the second memory control section 50 which is controlled by the main control section 30. In this case, daily sales data 12 is read from the fiscal memory 37 on the basis of a command (read command) for instructing to read daily sales data 12 from the fiscal data reading device 25, and outputs to the fiscal data reading device 25 through the communication IC 31 and the fiscal connector 29. Write receipt data 11 or daily sales data 12 of the day or accumulated in a predetermined period may be designated and read.

Next, the command output log creation section 66 of the main control section 30 will be described.

The function of the command output log creation section 66 is implemented by cooperation of hardware and software, for example, when the CPU executes a program.

The command output log creation section 66 adds log information to the command output log 40 stored in the ROM 32 with predetermined timing to update the command output log 40.

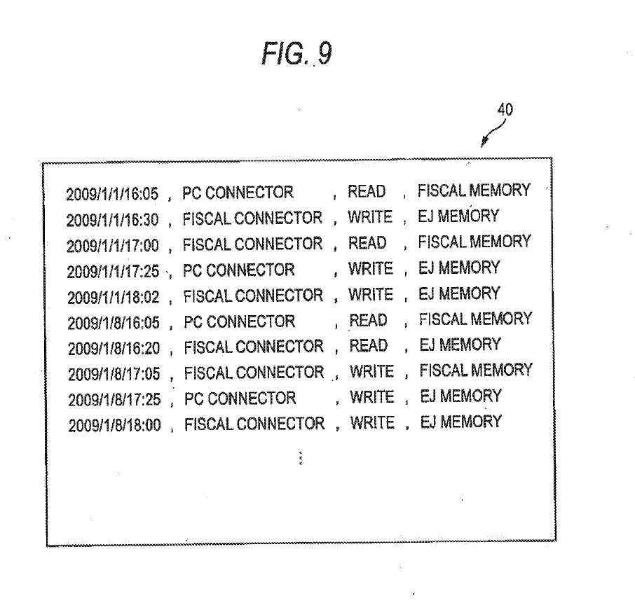

FIG. 9 is a diagram schematically showing the command output log 40 which is created by the command output log creation section 66.

Each time the main control section 30 outputs a read request command or a write request command to the first memory control section 35 or the second memory control section 50, the command output log creation section 66 adds the following log information to the command output log 40 stored in the ROM 32 to update the command output log 40. That is, the log information which is added to the command output log 40 references information in which the following kinds of information are associated with each other: the date and time (year, month, day, and time) at which a command is output, information indicating whether reading of data is instructed from the host computer 10 connected to the PC connector 24 or reading of data is instructed from the fiscal data reading device 25 connected to the fiscal connector 29, information indicating which of a read request command and a write request command is output, and information indicating to which of the EJ memory 34 and the fiscal memory 37 a command is output.

The command output log 40 may be a log that a read command or a write command is input to the main control section 30 through the communication IC 31 (interface).

Next, description will be provided for the first read/write performance log creation section 46 of the first memory control section 35.

The first read/write performance log creation section 46 adds log information to the first read/write performance log 45 stored in the EJ memory 34 to update the first read/write performance log 45.

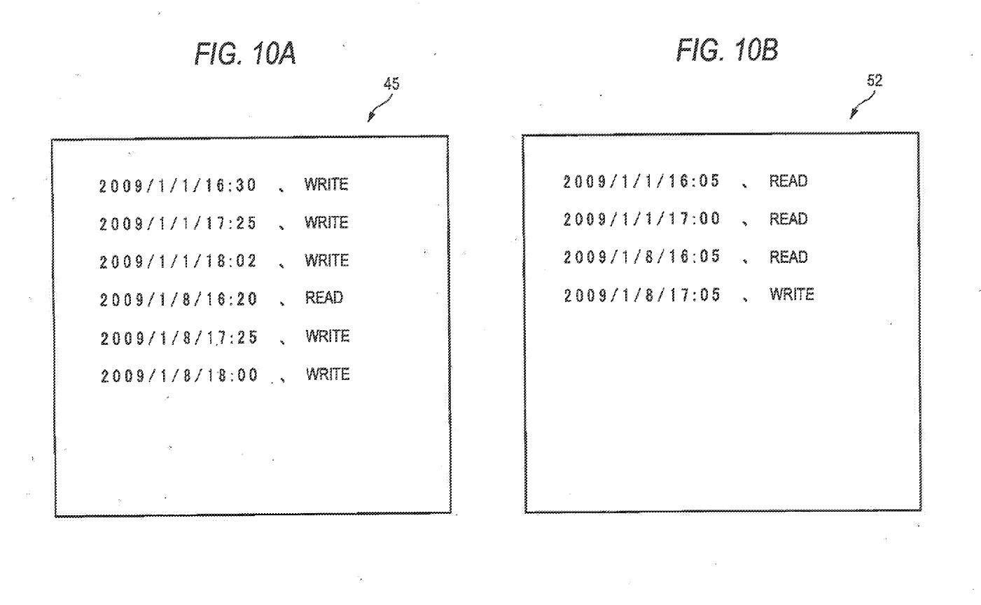

FIG. 10A is a diagram schematically showing the first read/write performance log 45.

Each time the first memory control section 35 actually writes write receipt data 11 into the EJ memory 34 or reads write receipt data 11 from the EJ memory 34, the first read/write performance log creation section 46 adds the following log information to the first read/write performance log 45 stored in the EJ memory 34 to update the first read/write performance log 45.

That is, the log information which is added to the first read/write performance log 45 references information in which information representing the date and time at which write receipt data 11 is written into the EJ memory 34 or write receipt data 11 is read from the EJ memory 34 and information representing whether data is written or read are associated with each other.

The first read/write performance log creation section 46 does not add log information with respect to the writing or reading of data to or from the EJ memory 34 each time the first read/write performance log 45 is updated.

Next, description will be provided for the second read/write performance log creation section 53 of the second memory control section 50.

The second read/write performance log creation section 53 adds log information to the second read/write performance log 52 stored in the fiscal memory 37 to update the second read/write performance log 52.

FIG. 10B is a diagram schematically showing the second read/write performance log 52.

Each time the second memory control section 50 writes daily sales data 12 into the fiscal memory 37 or reads daily sales data 12 from the fiscal memory 37, the second read/write performance log creation section 53 adds the following log information to the second read/write performance log 52 stored in the fiscal memory 37 to update the second read/write performance log 52. That is, the information which is added to the second read/write performance log 52 references information in which information representing the date and time at which daily sales data 12 is written into the fiscal memory 37 or daily sales data 12 is read from the fiscal memory 37 and information representing whether or data is written or read are associated with each other.

The second read/write performance log creation section 53 does not add log information with respect to the writing or reading of data to or from the fiscal memory 37 each time the second read/write performance log 52 is updated.

Next, the connection status log creation section 67 of the main control section 30 will be provided.

The connection status log creation section 67 adds log information to the connection status log 41 stored in the ROM 32 to update the connection status log 41.

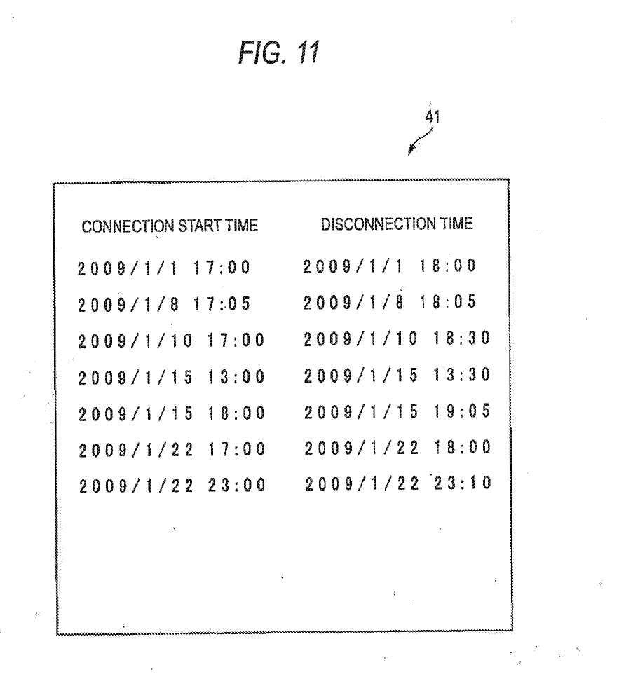

FIG. 11 is a diagram schematically showing the connection status log 41.

The connection status log 41 is a log representing the time period in which the fiscal data reading device 25 has been connected to the fiscal connector 29, and has log information in which information representing the date and time at which connection was started and information representing the date and time at which disconnection has been made are associated with each other.

As described above, while the communication IC 31 can detect that the fiscal data reading device 25 is connected to the fiscal connector 29, the connection status log creation section 67 detects the time period (connection start date and time and disconnection date and time), in which the fiscal data reading device 25 has been connected to the fiscal connector 29, on the basis of the detection value of the communication IC 31 and data input from the RTC 38 and adds each piece of log information to the connection status log 41 on the basis of the detected time period.

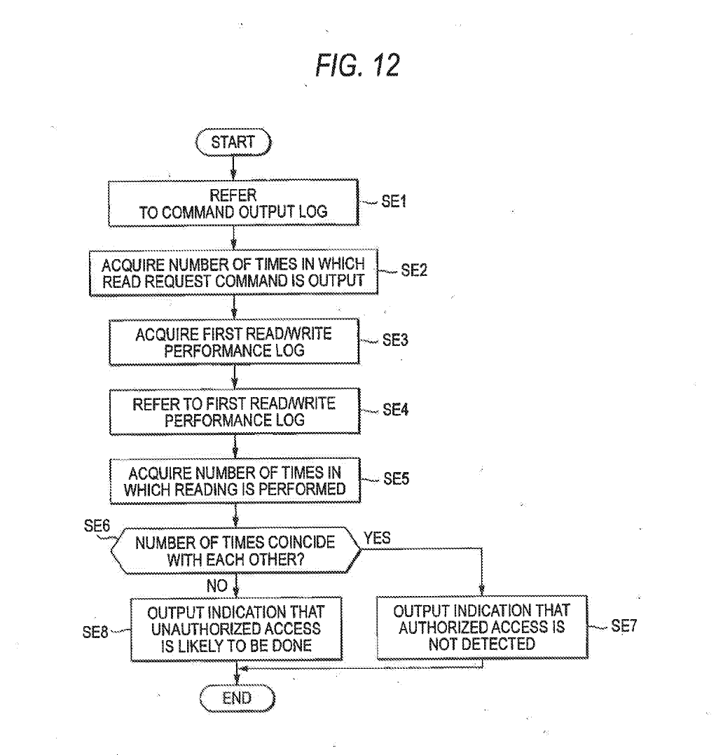

Next, description will be provided for the first unauthorized access detection section 70 of the main control section 30 with reference to a flowchart of FIG. 12.

With the following operation, the first unauthorized access detection section 70 detects that data is likely to have been read from the EJ memory 34 or the fiscal memory 37 through unauthorized access.

The operation of the first unauthorized access detection section 70 is implemented by cooperation of hardware and software, for example, when the CPU executes a program.

Referring to FIG. 12, the first unauthorized access detection section 70 references the command output log 40 stored in the ROM 32 (Step SE1), and acquires the number of times in which the main control section 30 has output the read request command for write receipt data 11 to the first memory control section 35 (Step SE2). In Step SE2, for example, the number of times in which the read request command has been output may be acquired for the date and time tracing back from the current point of time by a predetermined time.

Next, the first unauthorized access detection section 70 outputs a read request command for reading the first read/write performance log 45 from the EJ memory 34 to the first memory control section 35 to acquire the first read/write performance log 45 from the EJ memory 34 (Step SE3).

Next, the first unauthorized access detection section 70 references the acquired first read/write performance log 45 (Step SE4), and acquires the number of times in which the first memory control section 35 has actually read write receipt data 11 from the EJ memory 34 (Step SE5). In Step SE2, when the number of times in which the read request command has been output is acquired for the date and time tracing back from the current point of time by a predetermined time, in Step SE5, the number of times in which the first memory control section 35 has actually read data from the EJ memory 34 is acquired for the date and time tracing back from the current point of time by a predetermined time.

Next, the first unauthorized access detection section 70 compares the number of times acquired in Step SE2 in which the main control section 30 has output the read request command to the first memory control section 35 with the number of times acquired in Step SE5 in which the first memory control section 35 has actually read write receipt data 11 from the EJ memory 34 (Step SE6).

In this embodiment, in reading write receipt data 11 from the EJ memory 34, a read request command is output from the main control section 30 to the first memory control section 35, and the first memory control section 35 reads write receipt data 11 from the EJ memory 34 on the basis of the read request command. Thus, the number of times acquired in Step SE2 in which the main control section 30 has output the read request command to the first memory control section 35 should coincide with the number of times acquired in Step SE5 in which the first memory control section 35 has actually read write receipt data 11 from the EJ memory 34. Meanwhile, when a control section other than the main control section 30 is unauthorizedly connected to the first memory control section 35, and then data is read from the EJ memory 34 under the control of the relevant control section, the number of times do not coincide with each other. As a result, it is possible to detect that write receipt data 11 is likely to have been read through unauthorized access in accordance with whether or not the number of times coincide with each other.

In Step SE6, when the number of times coincide with each other (Step SE6: YES), the first unauthorized access detection section 70 generates data indicating that unauthorized access has not been detected, and outputs generated data to the host computer 10 or the fiscal data reading device 25 (Step SE7). The host computer 10 or the fiscal data reading device 25 displays the indication on a display section or the like on the basis of input data to give a notification.

Meanwhile, when the number of times do not coincide with each other (Step SE6: NO), that is, when write receipt data 11 is likely to be read through unauthorized access, the first unauthorized access detection section 70 generates data indicating that unauthorized access is likely to have been performed, and outputs generated data to the host computer 10 or the fiscal data reading device 25 (Step SE8). The host computer 10 or the fiscal data reading device 25 displays the indication on the display section on the basis of input data to give a notification.

As described above, the first unauthorized access detection section 70 detects that unauthorized access is likely to have been performed on the basis of the command output log 40 and the first read/write performance log 45.

Although in the example of FIG. 12, description has been provided for the operation of the first unauthorized access detection section 70 when it is detected that write receipt data 11 stored in the EJ memory 34 is likely to have been read unauthorizedly, the same means can also be used to detect that write receipt data 11 is likely to be written into the EJ memory 34 through unauthorized access. On the basis of the command output log 40 and the second read/write performance log 52, it is also possible to detect that daily sales data 12 stored in the fiscal memory 37 is likely to have been read unauthorizedly and to detect that daily sales data 12 is likely to be unauthorizedly written into the fiscal memory 37.

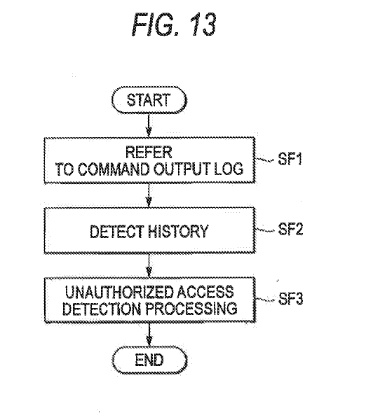

Next, description will be provided for the second unauthorized access detection section 71 of the main control section 30 with reference to a flowchart of FIG. 13.

With the following operation, the second unauthorized access detection section 71 detects that data is likely to have been read from the EJ memory 34 or the fiscal memory 37 through unauthorized access.

The operation of the second unauthorized access detection section 71 is implemented by cooperation of hardware and software, for example, when the CPU executes a program.

The following description will be provided for the operation of the second unauthorized access detection section 71 when it is detected that write receipt data 11 stored in the EJ memory 34 is likely to have been read or to be read unauthorizedly.

First, the second unauthorized access detection section 71 references the command output log 40 stored in the ROM 32 (Step SF1).

Next, the second unauthorized access detection section 71 detects the history of the date and time at which a read request command has been output from the main control section 30 to the first memory control section 35 on the basis of the command output log 40 (Step SF2).

Next, the second unauthorized access detection section 71 detects that write receipt data 11 is likely to have been read through unauthorized access on the basis of the history of the date and time detected in Step SF2 at which a read request command has been output from the main control section 30 to the first memory control section 35 (Step SF3).

Description will be provided for the operations in Steps SF2 and SF3 in connection with a specific example.

For example, the second unauthorized access detection section 71 determines whether a read request command is output equal to or greater than a predetermined number of times (for example, equal to or greater than ten times) at an interval (for example, an interval shorter than one minute) shorter than a predetermined interval for a predetermined limited time (for example, one hour) or not on the basis of the command output log 40, and when the read request command has been output in the above-described form, determines that data is likely to have been read through unauthorized access. Accordingly, usually, when there is no case where write receipt data 11 is output from the EJ memory 34 for a predetermined limited time at a comparatively short interval many times, it is possible to appropriately detect that unauthorized access is likely to have been performed. In particular, in this embodiment, as described above, write receipt data 11 is encrypted or put into a unique format through the function of the first memory control section 35 and then stored in the EJ memory 34. Thus, when a person who does not know how write receipt data 11 has been encrypted or put into a unique format connects an external device to, for example, the fiscal printer 1 and unauthorizedly reads write receipt data 11 from the EJ memory 34 using the external device, write receipt data 11 may be read many times for a short time. In such a case, however, since write receipt data 11 is encrypted or put into a unique format, the reading of write receipt data 11 through unauthorized access can be detected using the above-described method, making it possible to appropriately detect unauthorized access. In determining whether or not the read request command is output equal to or greater than a predetermined number of times for a predetermined limited time at an interval shorter than a predetermined interval, the predetermined time, the predetermined interval, and the predetermined number of times may be appropriately set in accordance with the status of a shop where the fiscal printer 1 is installed, the use mode of the fiscal printer 1, and the like.

For example, the second unauthorized access detection section 71 determines whether a read request command is output in a predefined time period or not on the basis of the command output log 40, and when the read request command has been output, determines that data is likely to have been read through unauthorized access. The predefined time period references, for example, the time period from the time when the shop is closed until the shop is opened, and in which write receipt data 11 is not read. When write receipt data 11 has been read during this time period, data is likely to have been read through unauthorized access.

The predefined time period may be not only the above-described time period, but also a combination of the day of the week and the time period or a specific time period on a specific day. In this way, it is possible to appropriately detect reading of write receipt data 11 through unauthorized access taking into consideration the specific situation of the shop, such as a working day and a holiday.

Although in the example of FIG. 13, description has been provided for the operation of the second unauthorized access detection section 71 when it is detected that write receipt data 11 stored in the EJ memory 34 is likely to have been read unauthorizedly, the same means can also be used to detect that write receipt data 11 is likely to have been written into the EJ memory 34 through unauthorized access. It is also possible to detect that daily sales data 12 stored in the fiscal memory 37 is likely to have been read unauthorizedly and to detect that daily sales data 12 is likely to have been written unauthorizedly into the fiscal memory 37.

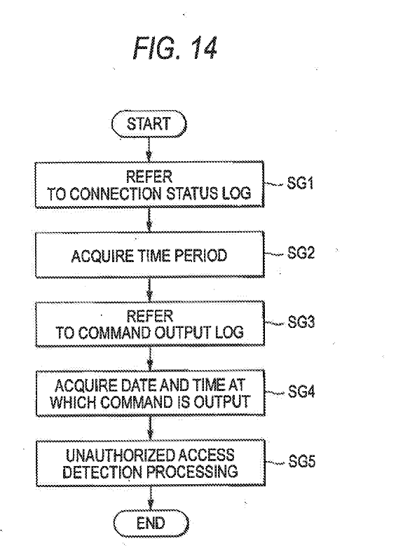

Next, description will be provided for the third unauthorized access detection section 72 of the main control section 30 with reference to a flowchart of FIG. 14.

With the following operation, the third unauthorized access detection section 72 detects that data is likely to have been read from the EJ memory 34 or the fiscal memory 37 through unauthorized access.

The operation of the third unauthorized access detection section 72 is implemented by cooperation of hardware and software, for example, when the CPU executes a program.

The following description will be provided for the operation of the third unauthorized access detection section 72 when write receipt data 11 stored in the EJ memory 34 is likely to have been read or to be read unauthorizedly.

First, the third unauthorized access detection section 72 references the connection status log 41 (Step SG1), and acquires the time period in which the fiscal data reading device 25 has been connected to the fiscal printer 1 (Step SG2).

Next, the third unauthorized access detection section 72 references the command output log 40 (Step SG3), and acquires the time period in which the main control section 30 has output a read request command for write receipt data 11 to the first memory control section 35 on the basis of an instruction of the fiscal data reading device 25 connected to the fiscal printer 1 (Step SG4).

Next, the third unauthorized access detection section 72 detects that write receipt data 11 has been read or is likely to have been read from the EJ memory 34 through unauthorized access on the basis of the time period acquired in Step SG2 in which the fiscal data reading device 25 has been connected to the fiscal printer 1 and the date and time acquired in Step SG4 at which the main control section 30 outputs the read request command for write receipt data 11 to the first memory control section 35 (Step SG5).

The operation of Step SG5 will be described in detail in connection with a specific example.

For example, in Step SG5, the third unauthorized access detection section 72 detects whether write receipt data 11 has been read on the basis of an instruction of the fiscal data reading device 25 after the fiscal data reading device 25 has been connected to the fiscal printer 1 in a time period other than the predefined predetermined time period or not on the basis of the time period acquired in Step SG2 in which the fiscal data reading device 25 has been connected to the fiscal printer 1 and the date and time acquired in Step SG4 at which the main control section 30 has output the read request command for write receipt data 11 to the first memory control section 35. When the reading has been performed, it is detected that write receipt data 11 is likely to have been read through unauthorized access.

This detection method is particularly effective in the following case. That is, the fiscal data reading device 25 is a device which is used when an authorized person, such as a government official, reads data including fiscal information, such as write receipt data 11 or daily sales data 12 stored in the fiscal printer 1, and the reading of data including the fiscal information is performed regularly in a predefined time period or is performed in a specific time period set in advance. When the fiscal data reading device 25 has been connected in a time period other than these time periods and then write receipt data 11 has been read, there is a possibility that a person who has unauthorizedly acquired the fiscal data reading device 25 has read write receipt data 11 using the fiscal data reading device 25. As a result, like the above-described method, it is detected whether or not write receipt data 11 has been read on the basis of an instruction of the fiscal data reading device 25 after the fiscal data reading device 25 has been connected to the fiscal printer 1 in a time period other than the predefined predetermined time period, making it possible to appropriately detect that write receipt data 11 is likely to have been read through unauthorized access.

For example, in Step SG5, on the basis of the time period acquired in Step SG2 in which the fiscal data reading device 25 has been connected to the fiscal printer 1 and the date and time acquired in Step SG4 at which the main control section 30 has output the read request command for write receipt data 11 to the first memory control section 35, regardless of the fiscal data reading device 25 being connected to the fiscal printer 1, the third unauthorized access detection section 72 detects whether or not no write receipt data 11 has been read while the fiscal data reading device 25 is being connected, or whether or not write receipt data 11 has been read frequently (for example, equal to or greater than a predetermined number of times, such as ten times) while the fiscal data reading device 25 is being connected. When no write receipt data 11 has been read or when write receipt data 11 has been read frequently, the third unauthorized access detection section 72 detects that write receipt data 11 is likely to have been read through unauthorized access. This is because the fiscal data reading device 25 is a dedicated device for reading data, such as write receipt data 11, and when data is not read regardless of the fiscal data reading device 25 being connected or when data has been read frequently, this form is different from the normal form in which the fiscal data reading device 25 reads data, such that data is likely to have been read through unauthorized access.

Although in the example of FIG. 14, description has been provided for the operation of the third unauthorized access detection section 72 when it is detected that write receipt data 11 stored in the EJ memory 34 is likely to has been read unauthorizedly, the same means can also be used to detect that write receipt data 11 is likely to have been written into the EJ memory 34 through unauthorized access. It is also possible to detect that daily sales data 12 stored in the fiscal memory 37 is likely to have been read unauthorizedly and to detect that daily sales data 12 is likely to have been written unauthorizedly into the fiscal memory 37.

As described above, the fiscal printer 1 of this embodiment includes command output log creation section 66, the first read/write performance log creation section 46, and the second read/write performance log creation section 53. The command output log creation section 66, the first read/write performance log creation section 46, and the second read/write performance log creation section 53 respectively creates the command output log 40, the first read/write performance log 45, and the second read/write performance log 52 which are the logs that the main control section 30 causes the first memory control section 35 or the second memory control section 50 to read write receipt data 11 or daily sales data 12, which is encrypted or put into a unique format, from the memory.

Accordingly, in a situation where data including fiscal information has been read in the past, on the basis of each log created by each log creation section, it is possible to detect that data including fiscal information is read in a form such that unauthorized access is likely to have been performed in the past. In particular, data including fiscal information is encrypted or put into a unique format through the function of the first memory control section 35 or the second memory control section 50 and stored in the memory. For this reason, when a person who does not know how data has been encrypted or put into a unique format has unauthorizedly accessed the memory and read data from the memory, it is determined that data is read in a form different from the normal form of reading data by a person who knows how data has been encrypted, such as frequently reading data from the memory for a short time. Thus, on the basis of each log created by each log creation section, it is possible to more appropriately detect reading of data through unauthorized access.

In this embodiment, the command output log creation section 66 creates the command output log 40 that the main control section 30 has output the read request command to the first memory control section 35 or the second memory control section 50. The first read/write performance log creation section 46 creates the first read/write performance log 45 that the first memory control section 35 has accessed the EJ memory 34 and read write receipt data 11 from the EJ memory 34. The second read/write performance log creation section 53 creates the second read/write performance log 52 that the second memory control section 50 has accessed the fiscal memory 37 and read daily sales data 12 from the fiscal memory 37.

In this embodiment, for example, in reading write receipt data 11 from the EJ memory 34, the main control section 30 outputs a read request command to the first memory control section 35, and the first memory control section 35 accesses the EJ memory 34 and reads write receipt data 11 from the EJ memory 34 on the basis of the read request command input from the main control section 30. Thus, the read request command output from the main control section 30 to the first memory control section 35 should correspond to processing in which the first memory control section 35 reads data from the EJ memory 34. When the read request command does not correspond to the processing for reading data from the EJ memory 34, there is a possibility that unauthorized access to the EJ memory 34 has been performed.

As a result, with the above-described configuration, it is possible to detect unauthorized access on the basis of the command output log 40, the first read/write performance log 45, and the second read/write performance log 52.

In this embodiment, the first unauthorized access detection section 70 detects the number of times, in which the main control section 30 has output the read request command for write receipt data 11 to the first memory control section 35, on the basis of the command output log 40, detects the number of times, in which the first memory control section 35 has accessed the EJ memory 34 and read write receipt data 11 from the EJ memory 34, on the basis of the first read/write performance log 45, and detects unauthorized access to the EJ memory 34 on the basis of the detection results. Similarly, the first unauthorized access detection section 70 detects the number of times, in which the main control section 30 has output the read request command for daily sales data 12 to the second memory control section 50, on the basis of the command output log 40, detects the number of times, in which the second memory control section 50 has accessed the fiscal memory 37 and read daily sales data 12 from the fiscal memory 37, on the basis of the second read/write performance log 52, and detects unauthorized access to the fiscal memory 37 on the basis of the detection results.

In this embodiment, for example, in reading write receipt data 11 from the EJ memory 34, the main control section 30 outputs a read request command to the first memory control section 35, and the first memory control section 35 accesses the EJ memory 34 and reads write receipt data 11 from the EJ memory 34 on the basis of the read request command input from the main control section 30. Thus, the number of times in which the read request command is output from the main control section 30 to the first memory control section 35 should coincide with the number of times of processing in which the first memory control section 35 reads write receipt data 11 from the EJ memory. When the number of times do not coincide with each other, there is a possibility that write receipt data 11 has been read from the EJ memory 34 through unauthorized access. The same can be applied to daily sales data 12 stored in the fiscal memory 37.

As a result, with the above-described configuration, it is possible for the first unauthorized access detection section 70 to appropriately detect reading of data through unauthorized access.

In this embodiment, each of the command output log creation section 66, the first read/write performance log creation section 46, and the second read/write performance log creation section 53 creates a log in association with the date and time on the basis of data input from the RTC 38 when the main control section 30 reads write receipt data 11 or daily sales data 12 from the EJ memory 34 or the fiscal printer 1.

Accordingly, it becomes possible to detect the history of the date and time at which the main control section 30 has caused the first memory control section 35 or the second memory control section 50 to read write receipt data 11 or daily sales data 12 from the EJ memory 34 or the fiscal memory 37, making it possible to detect unauthorized access to the EJ memory 34 or the fiscal memory 37 which is performed in a form different from normal access.

In this embodiment, the second unauthorized access detection section 71 detects the history of the date and time at which the main control section 30 causes the first memory control section 35 or the second memory control section 50 to read write receipt data 11 or daily sales data 12 from the EJ memory 34 or the fiscal memory 37 on the basis of the command output log 40, and detects unauthorized access to the EJ memory 34 or the fiscal memory 37 on the basis of the detected history.

Accordingly, it becomes possible to detect the difference between the history of access when normal access is performed and the history of access when unauthorized access is performed, making it possible to detect unauthorized access on the basis of the detected difference.

The fiscal printer 1 of this embodiment is configured such that the fiscal data reading device 25 which is allowed to read write receipt data 11 or daily sales data 12 from the EJ memory 34 or the fiscal memory 37 is connectable. The connection status log creation section 67 creates the connection status log 41 regarding the connection status of the fiscal data reading device 25.

Accordingly, it becomes possible to detect the connection status of the fiscal data reading device 25 on the basis of the connection status log 41, making it possible to detect unauthorized access on the basis of the detection result.

In this embodiment, the third unauthorized access detection section 72 detects unauthorized access to the EJ memory 34 or the fiscal memory 37 on the basis of the connection status log 41 and the command output log 40.

Accordingly, it becomes possible to detect the connection status of the fiscal data reading device 25 and the status of access to the EJ memory 34 or the fiscal memory 37 by the fiscal data reading device 25, making it possible to detect unauthorized access on the basis of the detection result.

The above-described embodiment is just one mode of the invention, and modifications and applications may be optionally made within the scope of the invention.

For example, although in the above-described embodiment, with regard to the operations of the first unauthorized access detection section 70, the second unauthorized access detection section 71, and the third unauthorized access detection section 72, the conditions of detecting unauthorized access have been described in connection with a specific example, these conditions may be appropriately changed in accordance with the status of a shop where the fiscal printer 1 is installed, the use status of the fiscal printer 1, the specification form, and the like.

What is claimed is:

1. An electronic apparatus, comprising:
a main control section that outputs data including fiscal information input from an interface;
a recording control section connected to the main control section, the recording control section that controls a recording section on the basis of the data output from the main control section to issue a receipt; and
a memory control section connected to the main control section and a memory, the memory control section that reads and writes the fiscal information from and to the memory under the control of the main control section,
wherein when the data is input to the main control section from the interface, the main control section controls the memory control section to write the fiscal data to the memory, and
wherein the electronic apparatus further comprises a log creation section that creates a log that the main control section controls the memory control section to read the fiscal information from the memory.

2. The electronic apparatus as set forth in claim 1,
wherein when the main control section controls the memory control section to read the fiscal information from the memory on the basis of a read command input from the interface, the main control section outputs a read request to the memory control section, and the memory control section accesses the memory, reads the fiscal information from the memory and outputs the fiscal information to the interface on the basis of the read request input from the main control section, and
wherein the log creation section creates a read request log which is a log that the read command is input from the interface or a log that the main control section outputs the read request to the memory control section, and a read performance log which is a log that the memory control section accesses the memory and read the fiscal information from the memory.

3. The electronic apparatus as set forth in claim 2, further comprising an unauthorized access detection section that detects the number of times in which the read command is input from the interface or the number of times in which the main control section outputs the read request to the memory control section on the basis of the read request log created by the log creation section, detects the number of the times in which the memory control section accesses the memory and reads the fiscal information from the memory on the basis of the read performance log, and then detects unauthorized access to the memory on the basis of detection results.

4. The electronic apparatus as set forth in claim 1, further comprising a timer section that measures date and time,
wherein the log creation section creates the log in association with date and time at which the main control section controls the memory control section to read the fiscal information from the memory, on the basis of the date and time measured by the timer section.

5. The electronic apparatus as set forth in claim 4, further comprising an unauthorized access detection section that detects a history of the date and time at which the main control section controls the memory control section to read the fiscal information from the memory on the basis of the log created by the log creation section, and then detects unauthorized access to the memory on the basis of the detected history.

6. The electronic apparatus as set forth in claim 1,
wherein the electronic apparatus is connectable to an external device which is authorized to read the fiscal information from the memory, and
wherein the log creation section creates a log regarding a connection status of the external device.

7. The electronic apparatus as set forth in claim 6, further comprising an unauthorized access detection section that detects unauthorized access to the memory on the basis of the log that the main control section controls the memory control section to read the fiscal information from the memory and the log regarding the connection status of the external device, which are created by the log creation section.

8. A method of controlling an electronic apparatus including: a main control section that outputs data including fiscal information input from an interface; a recording control section connected to the main control section, the recording control section that controls a recording section on the basis of the data output from the main control section to issue a receipt; and a memory control section connected to the main control section and a memory, the memory control section that reads and writes the fiscal information from and to the memory under the control of the main control section, the method comprising:
controlling the memory control section to write the fiscal data to the memory when the data is input to the main control section from the interface;
detecting that the main control section controls the memory control section to read the fiscal information from the memory; and
creating a log on the basis of a result of the detecting.
